(19) United States
(12) Patent Application Publication
(10) Pub. No.: US 2014/0106692 A1
(43) Pub. Date: Apr. 17, 2014

(54) TRANSMISSION APPARATUS, OUTPUT CONTROL METHOD FOR TRANSMISSION APPARATUS AND TRANSMISSION SYSTEM

(71) Applicant: FUJITSU LIMITED, Kawasaki-shi (JP)

(72) Inventors: Satoshi MATSUBARA, Kawasaki (JP); Hideharu SHAKO, Yokohama (JP)

(73) Assignee: FUJITSU LIMITED, Kawasaki-shi (JP)

(21) Appl. No.: 13/951,809

(22) Filed: Jul. 26, 2013

(30) Foreign Application Priority Data
Oct. 15, 2012 (JP) 2012-228433

(51) Int. Cl. H04B 1/04

(52) U.S. Cl. CPC H04B 1/04
USPC 455/115.1

(57) ABSTRACT

A transmission apparatus includes: an amplifier configured to amplify a transmission signal; a calculation unit configured to calculate a standing-wave ratio based on the transmission signal and a signal from an antenna to the amplifier; and a controller configured to switch a state of the amplifier based on the state of the amplifier and the standing-wave ratio.

### CROSS-REFERENCE TO RELATED APPLICATION

This application is based upon and claims the benefit of priority from the prior Japanese Patent Application No. 2012-228433 filed on Oct. 15, 2012, the entire contents of which are incorporated herein by reference.

### FIELD

The embodiment discussed herein is related to a transmission apparatus and an output control method.

### BACKGROUND

In wireless communication system base stations, transmitters transmit wireless signals. A transmitter includes a high-frequency amplifier and an antenna coupled to an output terminal of the high-frequency amplifier through a transmission line. In a state in which impedance matching is not achieved among the high-frequency amplifier, the transmission line, and the antenna, when a wireless signal is transmitted with a large amount of power, a reflected wave obtained by reflecting, at the antenna, the wireless signal which is output from the high-frequency amplifier is input to the high-frequency amplifier. When the transmission power of a wireless signal is increased, the power of the reflected wave is also increased, resulting in damage to the high-frequency amplifier due to the reflected wave.

Related art is disclosed in Japanese Laid-open Patent Publication No. 5-284047 or Japanese Laid-open Patent Publication No. 5-172879.

### SUMMARY

According to one aspect of the embodiments, a transmission apparatus includes: an amplifier configured to amplify a transmission signal; a calculation unit configured to calculate a standing-wave ratio based on the transmission signal and a signal from an antenna to the amplifier; and a controller configured to switch a state of the amplifier based on the state of the amplifier and the standing-wave ratio.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a transmission apparatus;

FIG. 2 illustrates an example of a process in a transmission apparatus; and

FIG. 3 illustrates an example of a hardware configuration of a transmission apparatus.

### DESCRIPTION OF EMBODIMENTS

To avoid damage to a high-frequency amplifier due to a reflected wave, for example, a transmitter measures the power of the reflected wave. When the measured power is larger than a certain level, it is determined that impedance matching is not achieved, and the output of the high-frequency amplifier is stopped.

When the transmission power is decreased, the power of the reflected wave to be measured is also decreased. Therefore, when the transmission power is small, no impedance mismatching may be detected. Consequently, instead of the power of a reflected wave, a voltage standing wave ratio (VSWR) may be measured as an indicator of the impedance mismatching. A voltage standing wave ratio is a ratio of the power of a reflected wave to the output power of a high-frequency amplifier. A voltage standing wave ratio is used as an indicator of the impedance mismatching, whereby impedance mismatching may be detected even in a state in which the transmission power is small.

However, an interfering wave from another system which is received at an antenna is not distinguishable from the reflected wave. Therefore, a high voltage standing wave ratio may be detected. Consequently, even when impedance matching is achieved, the output may be stopped, and no communication stability may be ensured.

Components having the same function may be designated with an identical reference numeral, and the description may be omitted or reduced.

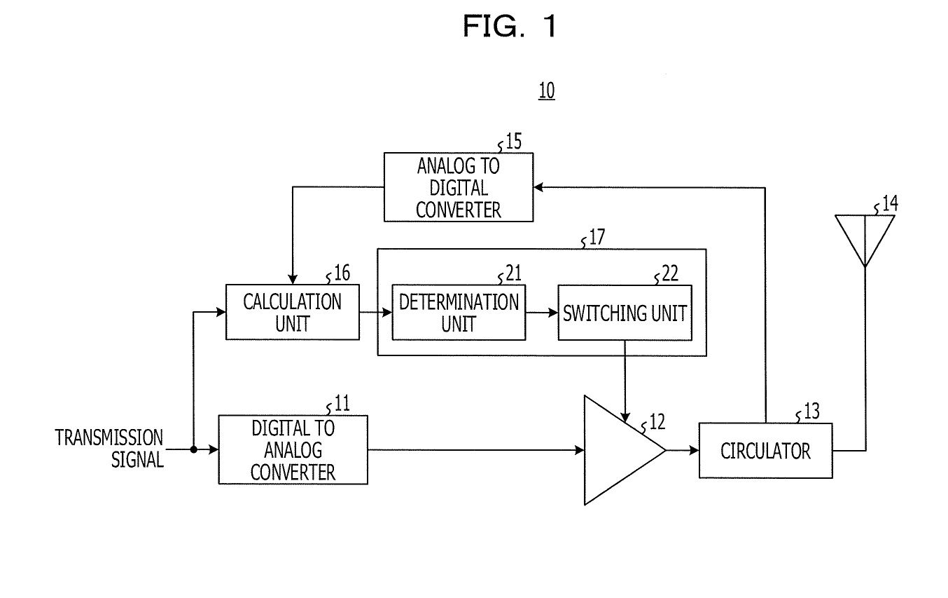

FIG. 1 illustrates an example of a transmission apparatus. In FIG. 1, a transmission apparatus 10 includes a digital to analog (DA) converter 11, an amplifier 12, a circulator 13, an antenna 14, an analog to digital (AD) converter 15, a calculation unit 16, and an output controller 17. The transmission apparatus 10 may be, for example, a transmission apparatus in a base station.

The DA converter 11 converts a transmission signal received from an upstream apparatus, from a digital signal to an analog signal, and outputs the transmission signal which is an analog signal obtained through the conversion, to the amplifier 12.

The amplifier 12 amplifies the received transmission signal. The amplifier 12 is switched to an output state in which an amplified transmission signal is output, or a halt state in which output of an amplified transmission signal is stopped, based on a control signal from the output controller 17.

The circulator 13 is coupled to each of the amplifier 12, the antenna 14, and the AD converter 15. The circulator 13 outputs a signal from a terminal corresponding to another terminal through which the signal is input. For example, the circulator 13 controls distribution of a signal. For example, a signal which is output from the amplifier 12 is output to the antenna 14. A signal which is input from the side of the antenna 14 to the amplifier 12 is output to the AD converter 15.

The AD converter 15 converts a signal which is output from the circulator 13, from an analog signal to a digital signal, and outputs the digital signal obtained through the conversion, to the calculation unit 16.

The calculation unit 16 calculates a standing-wave ratio based on the transmission signal and the signal which is output from the circulator 13, for example, a signal transmitted from the antenna 14 to the amplifier 12. For example, the calculation unit 16 calculates a voltage standing wave ratio (VSWR) based on the amplitude of the transmission signal and the amplitude of the signal which is output from the circulator 13. A voltage standing wave ratio is a ratio of the amplitude of a signal which is output from the circulator 13 to the amplitude of a transmission signal.

The output controller 17 switches the state of the amplifier 12 to an output state or the halt state, based on a first standing-wave ratio calculated in the output state of the amplifier 12, and a second standing-wave ratio calculated in the suspend state.

For example, the output controller 17 compares the first standing-wave ratio calculated in the output state of the amplifier 12 with a certain threshold. When the first standing-wave ratio is equal to or more than the certain threshold, the output controller 17 switches the state of the amplifier 12 from the output state to the suspend state.

The output controller 17 compares the second standing-wave ratio calculated in the suspend state with the certain threshold. When the second standing-wave ratio is less than the certain threshold, the output controller 17 restarts the output of the amplifier 12. When the second standing-wave ratio is equal to or more than the certain threshold, the output controller 17 continues stopping the output of the amplifier 12.

For example, the output controller 17 may include a determination unit 21 and a switching unit 22. The comparison between a standing-wave ratio and the certain threshold is performed by the determination unit 21, and the switching of the state of the amplifier 12 is performed based on a control signal which is output from the switching unit 22 to the amplifier 12.

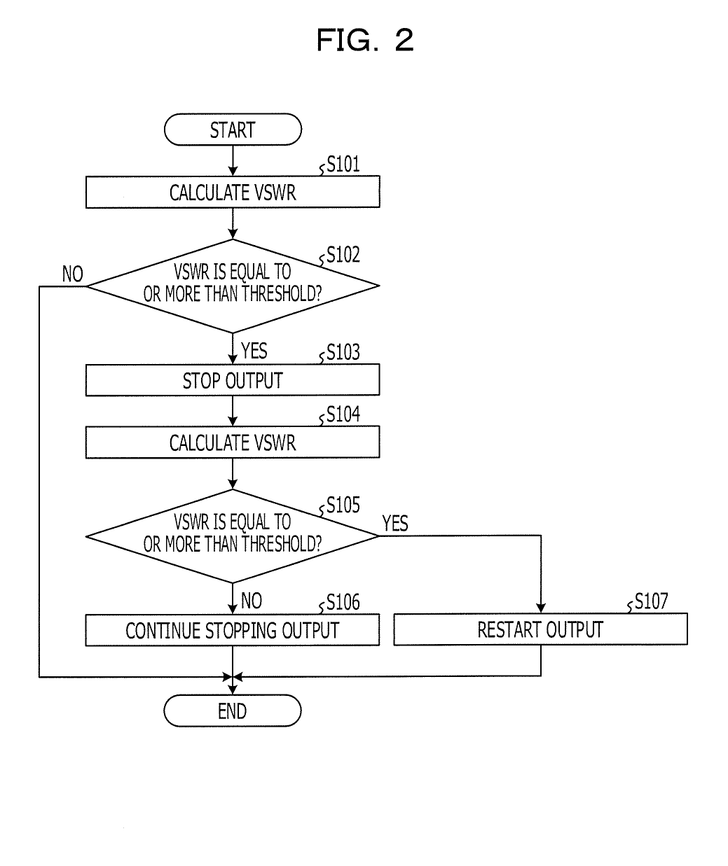

FIG. 2 illustrates an example of a process in a transmission apparatus. The transmission apparatus 10 illustrated in FIG. 1 may perform the process illustrated in FIG. 2.

The output state of the amplifier 12 may be the normal state. In the normal state of the amplifier 12, the calculation unit 16 calculates a standing-wave ratio based on the amplitude of a transmission signal and the amplitude of a signal which is output from the circulator 13 (in operation S101).

The output controller 17 determines whether or not the first standing-wave ratio calculated in the normal state of the amplifier 12 is equal to or more than the certain threshold (in operation S102).

If the first standing-wave ratio is equal to or more than the certain threshold (YES in operation S102), the output controller 17 stops the output of the amplifier 12 (in operation S103). Accordingly, the state of the amplifier 12 is switched to the suspend state. When the first standing-wave ratio is equal to or more than the certain threshold, an anomaly, for example, impedance mismatching, may occur in the transmission apparatus 10. In this case, the output controller 17 switches the state of the amplifier 12 to the suspend state.

In the suspend state of the amplifier 12, the calculation unit 16 calculates a standing-wave ratio based on the amplitude of the transmission signal and the amplitude of the signal which is output from the circulator 13 (in operation S104).

The output controller 17 determines whether or not the second standing-wave ratio calculated in the suspend state of the amplifier 12 is equal to or more than the certain threshold (in operation S105).

If the second standing-wave ratio is less than the certain threshold (NO in operation S105), the output controller 17 continues stopping the output of the amplifier 12 (in operation S106). For example, in the case where a standing-wave ratio is equal to or more than the certain threshold in the output state, if switching of the amplifier 12 to the halt state causes the standing-wave ratio to be decreased, the output signal of the amplifier 12 may cause the rise in the standing-wave ratio in the normal state of the amplifier 12. For example, in the case where a first standing-wave ratio is equal to or more than the certain threshold in the normal state of the amplifier 12, after the amplifier 12 is switched from the normal state to the suspend state, when a second standing-wave ratio is less than the certain threshold in the suspend state, it may be determined that an anomaly exists in the transmission apparatus 10.

If the second standing-wave ratio is equal to or more than the certain threshold (YES in operation S105), the output controller 17 restarts the output of the amplifier 12 (in operation S107). For example, in the case where a standing-wave ratio is equal to or more than the certain threshold in the normal state and where the standing-wave ratio is still equal to or more than the certain threshold even after the amplifier 12 is switched to the halt state, the output signals of the amplifier 12 may cause the rise in the standing-wave ratio in the normal state. The rise in the standing-wave ratio in the normal state may be caused by, for example, an interfering wave from another system. In the case where a first standing-wave ratio is equal to or more than the certain threshold in the normal state, after the amplifier 12 is switched from the normal state to the suspend state, when a second standing-wave ratio is equal to or more than the certain threshold in the suspend state, it may be determined that no anomaly exists in the transmission apparatus 10.

In the transmission apparatus 10, the calculation unit 16 calculates a standing-wave ratio based on a transmission signal and a signal transmitted from the antenna 14 to the amplifier 12. When the first standing-wave ratio calculated in the normal state of the amplifier 12 is equal to or more than the certain threshold, the output controller 17 switches the state of the amplifier 12 from the output state to the suspend state. When the second standing-wave ratio calculated in the temporary stopped state is equal to or more than the certain threshold, the output controller 17 restarts the output of the amplifier 12. When the second standing-wave ratio is less than the certain threshold, the output controller 17 continues stopping the output of the amplifier 12.

The output controller 17 determines whether an anomaly, for example, impedance mismatching, is present or absent in the transmission apparatus 10, based on the first standing-wave ratio calculated in the output state and the second standing-wave ratio calculated in the suspend state. Accordingly, accuracy of the determination as to whether impedance mismatching is present or absent may be improved. When it is determined that an anomaly is present, the output controller 17 continues stopping the output of the amplifier 12, whereby the amplifier 12 may be protected. When it is determined that an anomaly is absent, the output controller 17 restarts the output of the amplifier 12. Even in the case where a standing-wave ratio rises, when it is recognized that the rise is caused by, for example, an interfering wave from another system and that no anomaly exists in the transmission apparatus 10, the output of the amplifier 12 is not stopped, whereby the communication stability may be improved.

The transmission apparatus 10 illustrated in FIG. 1 may have a hardware configuration.

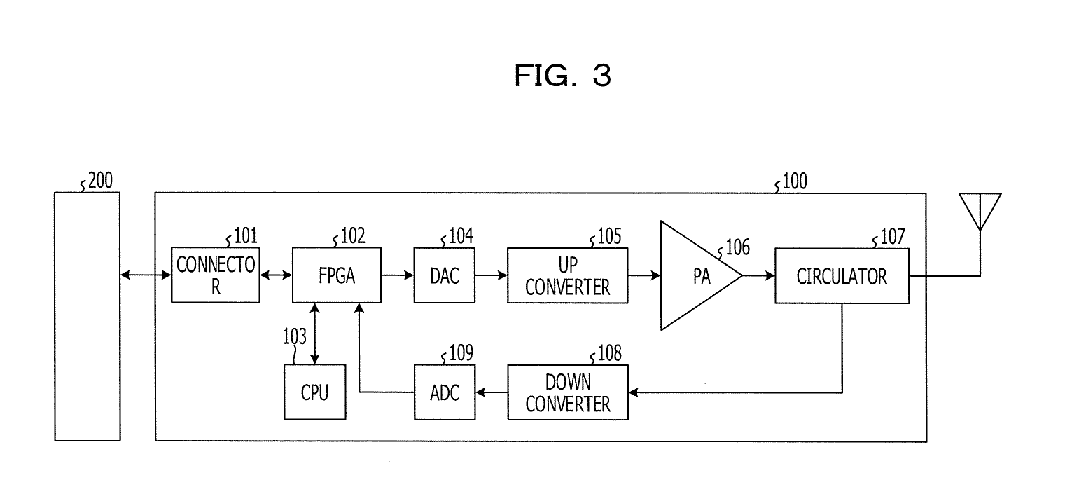

FIG. 3 illustrates an example of a hardware configuration of a transmission apparatus. In FIG. 3, a transmission apparatus 100 and a transmission control apparatus 200 are illustrated. As illustrated in FIG. 3, the transmission apparatus 100 includes a connector 101, a field programmable gate array (FPGA) 102, a central processing unit (CPU) 103, a digital to analog converter (DAC) 104, an up converter 105, a power amplifier (PA) 106, a circulator 107, a down converter 108, and an analog to digital converter (ADC) 109. The calculation unit 16 and the output controller 17 may correspond to integrated circuits, such as the FPGA 102 and the CPU 103.

For example, the process illustrated in FIG. 2 may be performed by executing programs prepared in advance by a computer. For example, programs corresponding to the processes performed by the calculation unit 16 and the output controller 17 may be stored in a memory, and the CPU 103 may read out each of the programs so as to execute it as a process.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
an amplifier configured to amplify a transmission signal;
a calculation unit configured to calculate a standing-wave ratio based on the transmission signal and a signal from an antenna to the amplifier; and
a controller configured to switch a state of the amplifier based on the state of the amplifier and the standing-wave ratio.

2. The transmission apparatus according to claim 1,
wherein the controller switches the state of the amplifier from a first state to a second state when a first standing-wave ratio calculated in the first state of the amplifier is equal to or more than a threshold.

3. The transmission apparatus according to claim 2,
wherein the controller switches the state of the amplifier to the first state when a second standing-wave ratio calculated in the second state of the amplifier is equal to or more than the threshold, and keeps the state of the amplifier in the second state when the second standing-wave ratio is less than the threshold.

4. The transmission apparatus according to claim 2,
wherein the first state indicates a state in which a signal is output from the amplifier, and the second state indicates a state in which no signal is output from the amplifier.

5. The transmission apparatus according to claim 1, further comprising:
a circulator configured to supply the signal from the antenna to the calculation unit.

6. The transmission apparatus according to claim 5,
wherein the circulator supplies an output signal of the amplifier to the antenna.

7. An output control method for a transmission apparatus, the method comprising:
calculating a first standing-wave ratio based on a transmission signal and a signal from an antenna to an amplifier when the amplifier is in a first state;
switching a state of the amplifier from the first state to a second state when the first standing-wave ratio is equal to or more than a threshold;
calculating a second standing-wave ratio based on the transmission signal and the signal from the antenna toward the amplifier when the amplifier is the second state;
switching the state of the amplifier from the second state to the first state when the second standing-wave ratio is equal to or more than the threshold; and
keeping the state of the amplifier in the second state when the second standing-wave ratio is less than the threshold.

8. The output control method for a transmission apparatus according to claim 7,
wherein the first state indicates a state in which a signal is output from the amplifier, and the second state indicates a state in which no signal is output from the amplifier.

9. A transmission system comprising:
an antenna;
a transmission apparatus configured to supply a transmission signal to the antenna; and
a transmission control apparatus configured to control the transmission apparatus,
wherein the transmission apparatus includes:
an amplifier configured to amplify a first signal so as to output the transmission signal;
a calculation unit configured to calculate a standing-wave ratio based on the first signal and a second signal from the antenna; and
a controller configured to switch a state of the amplifier based on the state of the amplifier and the standing-wave ratio.

10. The transmission system according to claim 9,
wherein the controller switches the state of the amplifier from a first state to a second state when a first standing-wave ratio calculated in the first state of the amplifier is equal to or more than a threshold.

11. The transmission system according to claim 10,
wherein the controller switches the state of the amplifier to the first state when a second standing-wave ratio calculated in the second state of the amplifier is equal to or more than the threshold, and
wherein the controller keeps the state of the amplifier in the second state when the second standing-wave ratio is less than the threshold.

12. The transmission system according to claim 10,
wherein the first state indicates a state in which a signal is output from the amplifier, and the second state indicates a state in which no signal is output from the amplifier.

13. The transmission system according to claim 10,
wherein the transmission apparatus further includes a circulator, provided between the amplifier and a terminal, configured to switch a destination of a signal input to the circulator.
